(19) United States
(12) Patent Application Publication
(10) Pub. No.: US 2019/0105144 A1
(43) Pub. Date: Apr. 11, 2019

(54) DENTAL APPLIANCE CASE WITH RETRACTABLE CORD AND ATTACHEMENT MECHANISM

(71) Applicant: Fabian Buenrostro, Merced, CA (US)

(72) Inventors: Fabian Buenrostro, Merced, CA (US); Brett Potter, Turlock, CA (US)

(21) Appl. No.: 16/157,085

(22) Filed: Oct. 10, 2018

Related U.S. Application Data
(60) Provisional application No. 62/570,093, filed on Oct. 10, 2017.
(60) Provisional application No. 62/595,590, filed on Dec. 7, 2017.
(60) Provisional application No. 62/667,614, filed on May 7, 2018.

(51) Int. Cl. A61C 19/02; A45F 5/02

(52) U.S. Cl. CPC A61C 19/02; A61C 7/08; A45F 5/02

(57) ABSTRACT

A dental appliance case having a retractable cord and anchor to allow the case to be attached to a travel case, backpack or clothing so that it can be easily toted with little risk of losing the case. The case may include a compartment for housing a dental appliance and a compartment for housing a retractable cord and a retraction mechanism.

### BACKGROUND OF THE INVENTION

### 1. Field of the Invention

The present invention relates to a dental appliance case with a retractable cord and attachment mechanism, and methods of making and using the same.

### 2. Background

Conventional dental appliance cases are often lost because they are an awkward size and shape, and they are typically set aside by the user and paid little attention. It is thus desirable to provide a dental appliance case that is less likely to be lost by the user.

### SUMMARY OF THE INVENTION

The present invention provides a dental appliance case having a retractable cord with an attachment mechanism on a distal end thereof. The dental appliance case may be operable to hold orthodontic retainers and other orthodontic appliances, dentures, and other dental devices. The dental appliance case may include a retraction cord having an attachment mechanism at a distal end thereof operable to connect to various structures. For example, the attachment mechanism may be a clip, clasp, D clip, Velcro strap, or other attachment mechanisms operable to attach to a satchel, back-pack, purse, belt loop, or other such structure that would allow the dental appliance case to be attached to the user's person or a bag carried by the user.

The dental appliance case may have several novel features that improve the utility of the case over conventional cases. The case may include a well for holding a user's retainer or other dental appliance. The well may have various shapes for accommodating the shape dental appliance and still allowing for the inclusion of a second compartment within the body of the case for housing a retraction mechanism and slack from the retraction cord. In some embodiments, the well may have a house shoe crescent shape that may be complementary to the dental appliance. The crescent shaped well allows for the second compartment to be positioned in the space surrounded by the crescent shaped well. The second compartment may contain a retraction mechanism for a retractable cord that allows that dental appliance case to be anchored to a garment, book bag, or other structure, while allowing the case to be drawn out on the retractable cord to provide easy, convenient access to the dental appliance case.

The second compartment or cord caddy may include a retraction mechanism for drawing in the retractable cord of the dental appliance case. The dental appliance case may be anchored to a structure, and may be pulled and drawn away from the structure on the retractable cord. The retraction mechanism may be a reel biased to rotate to wind the retractable cord around the wheel when the pulling force applied to the dental appliance case is too small to overcome the bias of the reel. The reel is configured such that the free end of the cord can be pulled, thereby rotating the reel, and when the end of the cord is released, the reel automatically rewinds the cord.

In some embodiments, the dental appliance may include a slot or other retaining structure for a dental floss pick (a device that includes a plastic stick with a tapered toothpick end and an opposite forked end spanned by a length of floss). The slot or other retaining structure may be positioned on the interior side of a hinged lid over the crescent shaped well for the dental appliance.

In some embodiments, the dental appliance may include a mirror for aiding the user in inserting the dental appliance into one's mouth. The mirror may be located on the exterior of the dental appliance case. For example, the mirror may be positioned on the outer surface of the hinged lid of the crescent well for the dental appliance. In other examples, the mirror may be locate on the interior of the hinged lid or the bottom surface of the case.

Additional aspects and objects of the invention will be apparent from the detailed descriptions and the claims herein.

### BRIEF DESCRIPTION OF THE DRAWINGS

FIG. 1 shows a view of the dental appliance case according to an embodiment of the present invention.

FIG. 2 shows a view of the dental appliance case according to an embodiment of the present invention.

FIG. 3 shows a view of the dental appliance case according to an embodiment of the present invention.

FIG. 4 shows a close-up, cross-sectional view of a retraction mechanism of a dental appliance case according to an embodiment of the present invention according to an embodiment of the present invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. However, it will be apparent to one skilled in the art that the present invention may be practiced without these specific details.

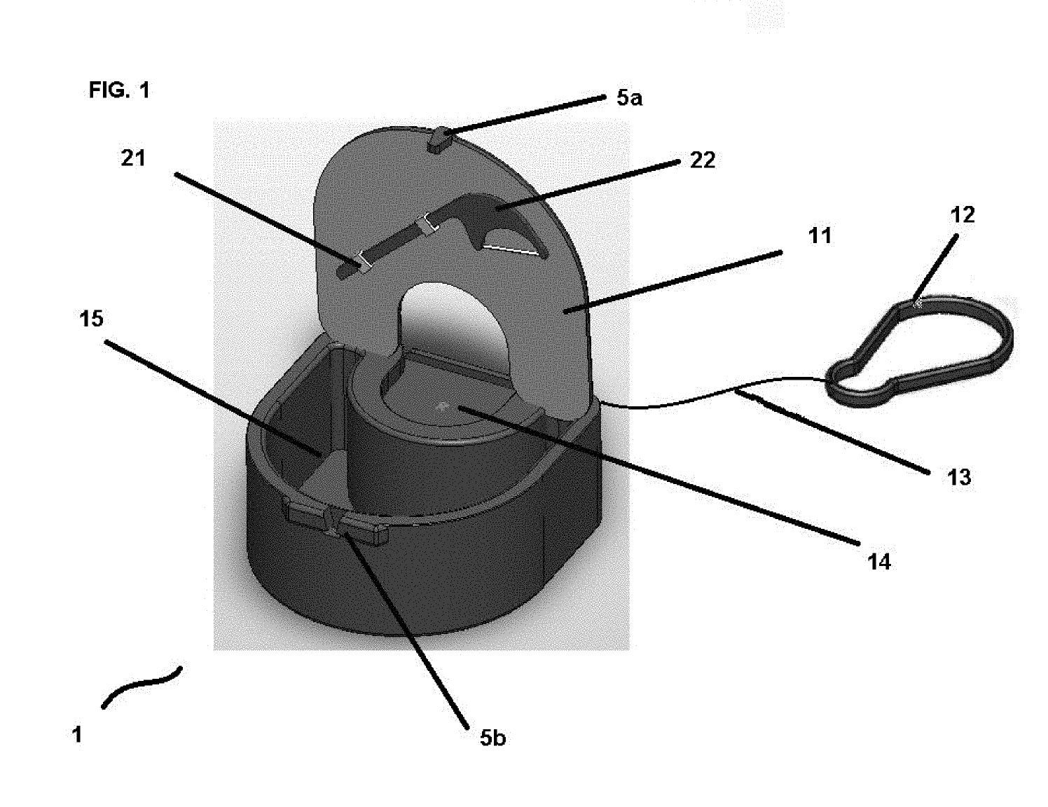

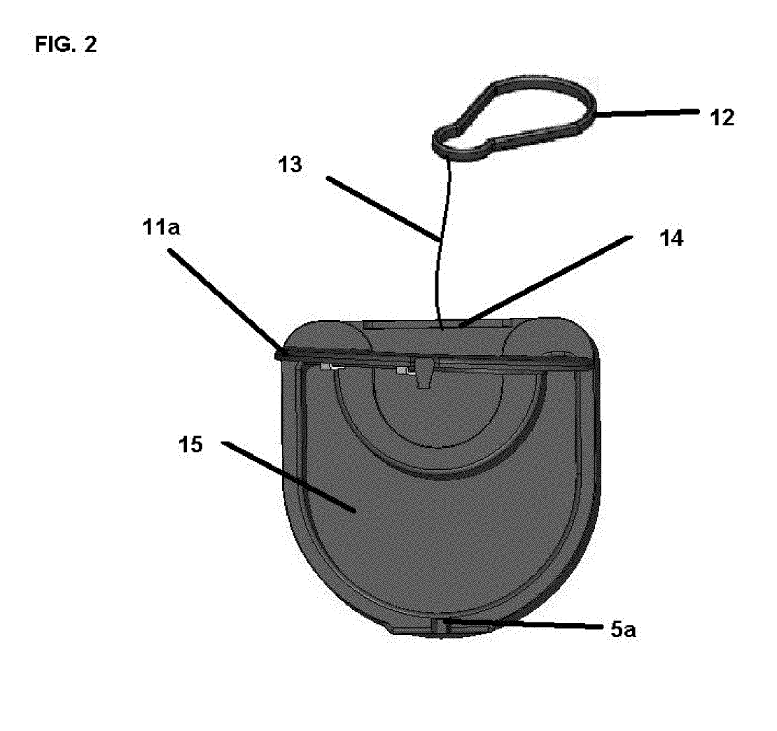

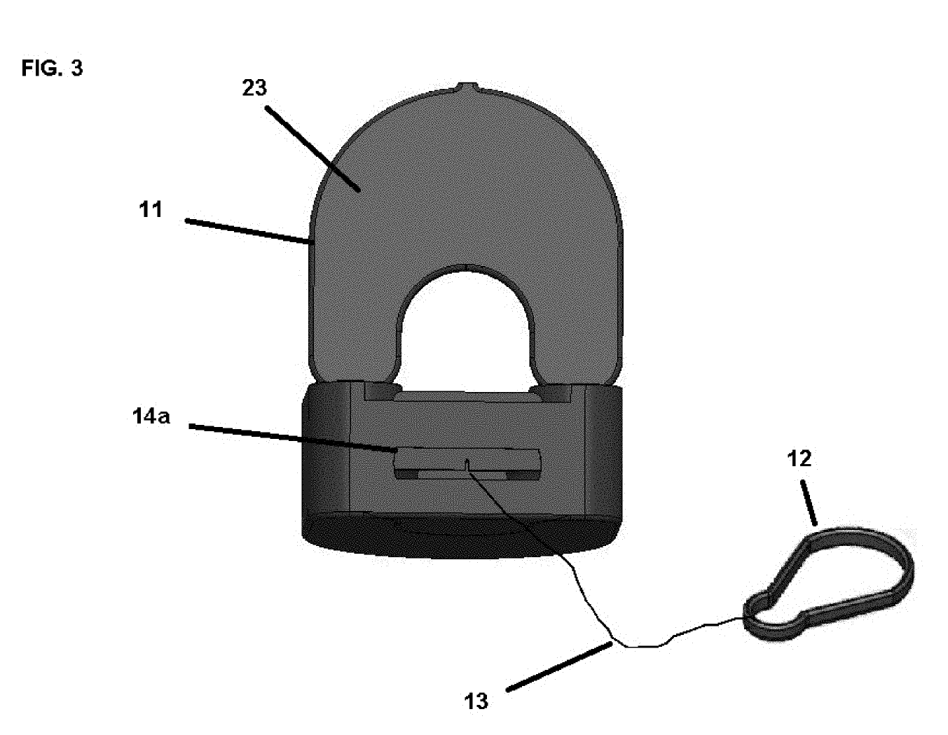

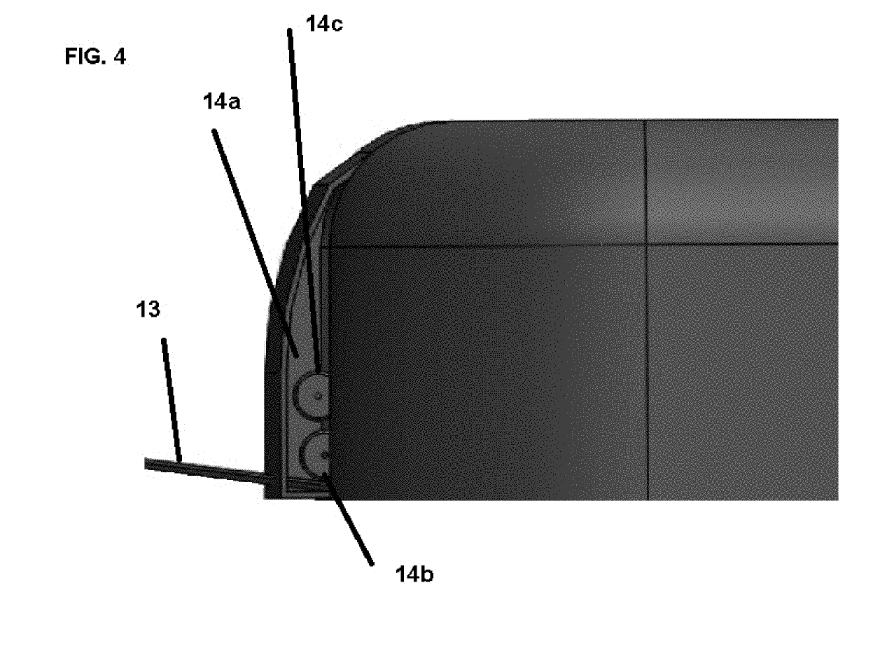

Referring to the drawings wherein like reference characters designate like or corresponding parts throughout the several views, and referring particularly to FIGS. 1-4, it is seen that the present invention includes various embodiments of a dental appliance case, and methods of using the same.

An example embodiment of the dental appliance case of the present invention is provided below in FIGS. 1-4. As depicted in the drawings, the dental appliance case 1 includes a crescent well 15 for holding a dental appliance, such as a retainer. The case 1 includes a pivoting hinged lid 11 for the crescent well 15 having a complementary shape to the perimeter of the crescent well 15. The case lid 11 includes a mirror 23 that cover at least a portion of the hinged lid, and may be recessed into the lid to minimize contact of the mirror 23 with surfaces when the case is set upon such surfaces and scratches are thereby avoided. The hinged lid 11 may have a clasp having interlocking clips 5a and 5b that hold it in the closed position over the crescent well 15 when the interlocking clips 5a, 5b are engaged with each other. The clasp may be a pressure fit clasp. A floss pick retainer 21 may be included on the inner surface of the lid 11 to provide convenient storage and access to a pick or floss pick 22 after meals when one is away from home.

The crescent well 15 surrounds and accommodates a second compartment 14 for housing the retraction mechanism 4a. The anchor 12 may be connected to the case 1 by the retraction cord 13a, and may function to connect the case 1 to a backpack, belt-loop or other structure that allows the case 1 to be easily ported by the user thereof, without the need to pay special attention to the case 1. The retraction cord may be connected to a retraction mechanism 14a in the cord compartment 14.

In some embodiments, the retraction mechanism 14a may include s biased wheel 14b for reeling in the retractable cord 13 and a second biased wheel 14c to provide the force for spinning the reeling wheel. The retraction mechanism is housed within the cord compartment 14 in the rear portion of the dental appliance case 1. Thus, the dental appliance case 1 may be a self-contained unit that includes the retraction mechanism 14a therein. The present invention is not limited to the forgoing example, and other embodiments having different configurations are within the scope of the present invention.

The foregoing descriptions of specific examples and embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed:

1. A dental appliance case comprising:
a. an outer case;
b. an internal compartment for housing a dental appliance;
c. a retractable cord and an anchor for attaching said case to an external structure; and
d. a second internal compartment for housing a retraction mechanism for retracting said cord.

2. The case of claim 1, wherein said internal compartment has a crescent shape that is complementary to an orthodontic retainer appliance.

3. The case of claim 1, wherein said internal compartment surrounds said second internal compartment within the outer case.

4. The case of claim 1, wherein the retraction mechanism includes a biasing mechanism for pulling said retractable cord into said second internal compartment.

5. The case of claim 4, wherein slack of said retractable cord is stored in said second internal compartment.

6. The case of claim 1, further comprising a lid over said internal compartment, but not said second internal compartment.

7. The case of claim 6, wherein said lid includes a mirror.

8. The case of claim 6, wherein said lid includes a pick retainer for holding a pick or floss pick.

9. The case of claim 1, wherein said anchor is a clip structure that can be removably attached to a closed-loop structure, such as a belt-loop or backpack strap.

10. A dental appliance case comprising:
a. an outer case;
b. an internal crescent-shaped compartment having a shape complementary to an orthodontic retainer appliance; and
c. a second internal compartment nested within said internal crescent-shaped compartment for housing a retraction mechanism and a retractable cord.

11. The case of claim 10, wherein the retraction mechanism includes a biasing mechanism for pulling said retractable cord into said second internal compartment.

11. The case of claim 11, wherein slack of said retractable cord is stored in said second internal compartment.

13. The case of claim 10, further comprising a lid over said internal compartment, but not said second internal compartment.

14. The case of claim 13, wherein said lid includes a mirror.

15. The case of claim 13, wherein said lid includes a pick retainer for holding a pick or floss pick.

16. The case of claim 10, wherein said anchor is a clip structure that can be removably attached to a closed-loop structure, such as a belt-loop or backpack strap.

17. A dental appliance case comprising:
a. an outer case;
b. an internal crescent-shaped compartment having a shape complementary to an orthodontic retainer appliance;
c. a lid closable over said internal crescent-shaped compartment;
d. a retractable cord and an anchor attached to a distal end of said retractable cord;
e. a retraction mechanism connected to a proximal end of said retractable cord having a biasing component for drawing in said retractable cord; and
f. a second internal compartment nested within said internal crescent-shaped compartment for housing said retraction mechanism and said retractable cord.

18. The case of claim 17, wherein slack of said retractable cord is stored in said second internal compartment.

19. The case of claim 17, wherein said lid includes a mirror.

20. The case of claim 17, wherein said lid includes a pick retainer for holding a pick or floss pick.
